(19) United States
(12) Patent Application Publication
(10) Pub. No.: US 2025/0372629 A1
(43) Pub. Date: Dec. 4, 2025

(54) SILICON COMPOSITE ANODE MATERIALS FOR ENERGY STORAGE DEVICES, AND METHODS THEREOF

(71) Applicant: Tesla, Inc., Austin, TX (US)

(72) Inventors: Nupur Nikkan Sinha, Fremont, CA (US); Snehashis Choudhury, Sunnyvale, CA (US); Sanketh Gowda, Palo Alto, CA (US)

(21) Appl. No.: 19/107,518

(22) PCT Filed: Sep. 28, 2023
(86) PCT No.: PCT/US2023/033985

§ 371 Date: Feb. 27, 2025

Related U.S. Application Data
(60) Provisional application No. 63/377,982, filed on Sep. 30, 2022.

(51) Int. Cl. H01M 4/36; H01M 4/02; H01M 4/133; H01M 4/134; H01M 4/1393; H01M 4/1395; H01M 4/38; H01M 4/587; H01M 4/62

(52) U.S. Cl. CPC H01M 4/366; H01M 4/133; H01M 4/134; H01M 4/1393; H01M 4/1395; H01M 4/386; H01M 4/587; H01M 4/622; H01M 4/625; H01M 2004/027

(57) ABSTRACT

Methods for forming dry composite material for an energy storage device electrode are provided. The method may comprise forming a slurry by mixing a solvent, a silicon active material, a carbon active material, and a carbon additive; and forming the dry composite material comprising the silicon active material, the carbon active material, and the carbon additive by removing the solvent. The carbon additive, silicon active material and carbon active material are substantially homogeneously dispersed in the dry composite material. The dry composite material may be used to form a dry electrode film in dry fabrication processes.

### CROSS-REFERENCE TO RELATED APPLICATION

This application claims the benefit of U.S. Provisional Application No. 63/377,982, entitled SILICON COMPOSITE ANODE MATERIALS FOR ENERGY STORAGE DEVICES, AND METHODS THEREOF, filed on Sep. 30, 2022, and which is incorporated by reference herein in its entirety.

### BACKGROUND

### Field

The present invention relates generally to energy storage devices, and specifically to materials and methods for dry electrode films including silicon active material.

### Description of the Related Art

Lithium ion batteries have been relied on as a power source in numerous commercial and industrial uses, for example, in consumer devices, productivity devices, and in battery-powered vehicles. One pathway for improving the storage potential of an energy storage device is to use an active material having a high theoretical capacity, for example silicon materials, such as silicon, silicon oxide (SiOₓ), silicon carbon (SiC), or silicon carbon composite (Si/C). Silicon has a theoretical capacity of about 3560 mAh/g, which is about 10 times of the capacity of graphite at 356 mAh/g. However, electrode films may suffer from reduced performance due to the mechanical properties of the film components, and interactions therebetween. Specifically, additional degradation may be observed in electrodes incorporating silicon materials, which may undergo significant volumetric changes during cell cycling.

One method used to maintain the electrical contact during cycling of an electrode comprising silicon materials is to use carbon additives, such as carbon nanotube (CNT) and carbon black, to form a carbon matrix across the electrode. It may be possible to uniformly distribute binders, graphite, carbon additives and silicon materials in conventional wet electrode film processes. However, it may be more difficult to uniformly disperse binders, graphite, silicon materials, and/or the carbon additives without the use of a processing solvent. As such, new compositions and processes for improving the dispersal of materials within an electrode film are necessary.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In one aspect, a dry composite material for an energy storage device is disclosed. The dry composite material comprises a silicon active material; a carbon active material; and a carbon additive, wherein the carbon additive, silicon active material and carbon active material are substantially homogeneously dispersed throughout the dry composite material.

In some embodiments, the carbon additive is selected from the group consisting of carbon nanotubes, a carbon black, carbon nanofibers, and combinations thereof. In some embodiments, the carbon additive is a conductive additive. In some embodiments, the carbon additive forms a matrix.

In some embodiments, a surface area of the dry composite material is at least about 1.2 m²/g. In some embodiments, a D50 particle size of the dry composite material is at least about 16 μm. In some embodiments, the silicon active material is selected from the group consisting of silicon, a silicon derivative, and combinations thereof. In some embodiments, the silicon derivative is selected from the group consisting of silicon oxide (SiOₓ), a silicon carbide (SiC), a silicon-carbon composite (Si/C), and combinations thereof. In some embodiments, the carbon active material comprises graphite, soft carbon, hard carbon, and combinations thereof. In some embodiments, the dry composite material further comprises a composite binder. In some embodiments, the composite binder is selected from the group consisting of a polyacrylic acid (PAA), a cellulose, an alginate (Alg), an acrylate, an acrylamide, a polyacrylamide (PAM), a gum, a sulfonated tetrafluoroethylene based fluoropolymer-copolymer, a network polymer, an acrylonitrile, an amide based binder, an imide based binder, an amide-imide binder, polyvinylidene fluoride (PVDF), copolymers thereof, and combinations thereof. In some embodiments, the dry composite material is substantially free of solvent residue.

In another aspect, an electrode film comprising a dry composite material is disclosed. In some embodiments, the electrode film further comprises a dry binder. In some embodiments, the dry binder is selected from the group consisting of polytetrafluoroethylene (PTFE), ultra-high molecular weight polyethylene (UHMWPE), polyvinylidene fluoride (PVDF), an acrylate, an acrylonitrile imide, an amide, and combinations thereof. In some embodiments, the electrode film is free-standing and substantially free of solvent residue.

In another aspect, an electrode comprising an electrode film disposed over a current collector is disclosed. In another aspect, an energy storage device comprising an electrode is disclosed. In some embodiments, the capacity of the electrode after 100 cycles is at least about 95% of the capacity of the electrode in a first cycle. In some embodiments, the capacity of the electrode is at least about 400 mAh/mg in a first cycle.

In another aspect, a method for preparing a dry composite material for an energy storage device electrode is disclosed. The method comprises forming a mixture comprising a silicon active material, a carbon active material, and a carbon additive; and forming the dry composite material comprising the silicon active material, the carbon active material, and the carbon additive, wherein the carbon additive, silicon active material and carbon active material are substantially homogeneously dispersed in the dry composite material.

In some embodiments, the mixture is a slurry and further comprises a solvent, and wherein forming the dry composite material further comprises removing the solvent. In some embodiments, the mixture further comprises a composite binder. In some embodiments, forming the dry composite material is a process selected from the group consisting of spray drying, tri-kneader mixing, fluidized bed mixing, freeze dry mixing, milling, mechanofusion, and combinations thereof.

In another aspect, a method for preparing a dry electrode film for an energy storage device electrode is disclosed. The method comprises mixing a dry composite material with a dry binder to form a dry bulk mixture; and forming a free-standing dry electrode film from the dry electrode film mixture. In some embodiments, forming the free-standing dry electrode film is a dry process.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

These and other features, aspects, and advantages of the present disclosure are described with reference to the drawings of certain embodiments, which are intended to illustrate certain embodiments and not to limit the invention.

FIG. 1 is a schematic diagram of an energy storage device comprising one or more electrode films.

FIG. 2 is an illustration of a dry composite material, according to some embodiments.

FIG. 3 is a process flow diagram of an embodiment of a process for forming a dry composite material.

FIG. 4A is a schematic diagram of an embodiment of an apparatus for fabricating a dry composite material.

FIG. 4B is a process flow diagram of an embodiment of a process for forming a dry composite material.

FIG. 5 is a process flow diagram of an embodiment of a process for forming a dry electrode film.

FIG. 6 illustrates a line graph of the size distribution of the dry composite materials according to some embodiments and a control material.

FIG. 7A is a scanning electron microscope (SEM) image of the surface of a dry composite material according to some embodiments.

FIG. 7B is a scanning electron microscope (SEM) image of the surface of a dry composite material according to some embodiments, and is a more focused image of the SEM image from FIG. 7A.

FIG. 8 illustrates a bar and line graph of capacities and first cycle efficiencies (FCE) of half-cells fabricated with anodes comprising dry composite materials according to some embodiments, and a control anode.

FIG. 9A illustrates a bar and line graph of the capacities and first cycle efficiencies (FCE) of full-cells with anodes comprising dry composite materials according to some embodiments, and a control anode.

FIG. 9B illustrates a line graph of the capacity retentions of full-cells with anodes comprising dry composite materials according to some embodiments, and control anodes.

### DETAILED DESCRIPTION

Provided herein are various embodiments of dry composite materials and electrode films for use in energy storage devices. In particular, in certain embodiments, energy storage devices disclosed herein include electrode films including a dry composite material comprising a silicon active material, a carbon active material, and a carbon additive (e.g., carbon nanotubes). The dry composite material when utilized in a dry electrode film manufacturing process produced electrode films that were discovered to exhibit improved homogeneity, stability, and electrical properties. Also provided are methods for processing such dry composite materials and for incorporating the dry composite materials into the electrode films. The present disclosure reveals that increased uniformity of distribution of materials in the electrode films can be realized when a dry composite material is fabricated and used for the electrode films.

A dry electrode film fabricated using a dry composite material made from one or more processes described herein may demonstrate improved electrical properties, for example, due to improved uniform distribution of one or more components of the electrode film. Disclosed herein are materials and methods providing active material(s) with more uniform distribution and less aggregation during fabrication. Certain embodiments of energy storage devices provided herein may provide more uniform distribution of graphitic materials and/or silicon active materials following processing. In particular, self-supporting and/or free-standing electrode films including such active material(s) are provided. One or more processes described herein may avoid the aggregation, poor distribution, phase separation and failure in wrapping the active materials. In some embodiments, manufacturing costs may be reduced when reducing or eliminating the use of high-shear apparatus, and associated equipment, such as air compressors and/or associated mixers.

### Definitions

As used herein, the terms “battery” and “capacitor” are to be given their ordinary and customary meanings to a person of ordinary skill in the art. The terms “battery” and “capacitor” are nonexclusive of each other. A capacitor or battery can refer to a single electrochemical cell that may be operated alone, or operated as a component of a multi-cell system.

As used herein, the voltage of an energy storage device is the operating voltage for a single battery or capacitor cell. Voltage may exceed the rated voltage or be below the rated voltage under load, or according to manufacturing tolerances.

As provided herein, a “self-supporting” electrode film is an electrode film that incorporates binder matrix structures sufficient to support the film or layer and maintain its shape such that the electrode film or layer can be free-standing. When incorporated in an energy storage device, a self-supporting electrode film or active layer is one that incorporates such binder matrix structures. Generally, and depending on the methods employed, such electrode films or active layers are strong enough to be employed in energy storage device fabrication processes without any outside supporting elements, such as a current collector, support webs or other structures, although supporting elements may be employed to facilitate the energy storage device fabrication processes. For example, a “self-supporting” electrode film can have sufficient strength to be rolled, handled, and unrolled within an electrode fabrication process without other supporting elements. A “free-standing” electrode film is a self-supporting electrode film that is without outside supporting elements. A dry electrode film, such as a cathode electrode film or an anode electrode film, may be self-supporting.

As provided herein, a “solvent-free” electrode film is an electrode film that contains no detectable processing solvents, processing solvent residues, or processing solvent impurities. Processing solvents or traditional solvents include organic solvents. A dry electrode film, such as a cathode electrode film or an anode electrode film, may be solvent-free.

A “wet” electrode or “wet process” electrode is an electrode prepared by at least one step involving a slurry of active material(s), binder(s), and processing solvents, processing solvent residues, and/or processing solvent impurities. A wet electrode may optionally include additive(s). A wet process electrode may still contain solvent, solvent residues and/or solvent impurities even after a drying step is applied to the electrode film due to solvent trapped within the volume of the electrode film and the limited temperatures and/or drying times required to be applied to the electrode in order to maintain performance.

As provided herein, a “dry” composite material is a composite material that does not, or does not substantially, contain or contain detectable amounts of processing solvents, processing solvent residues, and/or processing solvent impurities. A composite material manufactured from a process that may include a solvent (e.g., a slurry of materials) may be a “dry” composite material through, for example, a manufacturing process that sufficiently evaporates the solvent, solvent residues and solvent impurities and/or additional drying processing steps.

### Energy Storage Device

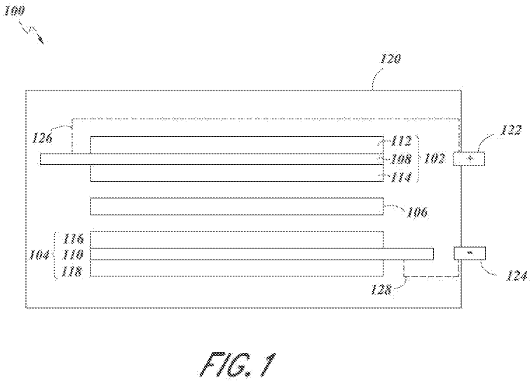

FIG. 1 shows a side cross-sectional schematic view of an example of an energy storage device 100. The energy storage device 100 may be any number of energy storage devices, such as a lithium ion capacitor, lithium ion battery, or an electric double layer capacitor. Of course, other energy storage devices are within the scope of the invention, and device 100 can be other types of capacitors, batteries, capacitor-battery hybrids, or fuel cells. The energy storage device 100 can have a first electrode 102, a second electrode 104, and a separator 106 positioned between the first electrode 102 and second electrode 104. For example, the first electrode 102 and the second electrode 104 may be placed adjacent to respective opposing surfaces of the separator 106. The first electrode 102 may comprise a cathode and the second electrode 104 may comprise an anode, or vice versa. The energy storage device 100 may include an electrolyte to facilitate ionic communication between the electrodes 102, 104 of the energy storage device 100. For example, the electrolyte may be in contact with the first electrode 102, the second electrode 104 and the separator 106. The electrolyte, the first electrode 102, the second electrode 104, and the separator 106 may be received within an energy storage device housing 120. For example, the energy storage device housing 120 may be sealed subsequent to insertion of the first electrode 102, the second electrode 104 and the separator 106, and impregnation of the energy storage device 100 with the electrolyte, such that the first electrode 102, the second electrode 104, the separator 106, and the electrolyte may be physically sealed from an environment external to the housing.

The separator 106 can be configured to electrically insulate two electrodes adjacent to opposing sides of the separator 106, such as the first electrode 102 and the second electrode 104, while permitting ionic communication between the two adjacent electrodes. The separator 106 can comprise a variety of porous or nonwoven electrically insulating materials. In some embodiments, the separator 106 can comprise a polymeric material. The separator 106 can comprise a composite of polymeric materials. The separator 106 can comprise a composite of one or more polymeric materials with a ceramic, and/or metal oxide. The ceramic or metal oxide can be a powder. For example, the separator 106 can comprise a cellulosic material, such as paper. The separator 106 can comprise a porous or nonwoven polyethylene (PE) material. The separator 106 can comprise polytetrafluoroethylene material, such as a porous polytetrafluoroethylene material. The separator 106 can comprise a polypropylene (PP) material, such as a porous or nonwoven polypropylene (PP) material. The separator 106 can comprise a polyethylene coating, for example, on a porous or nonwoven polypropylene material or a composite of polymeric materials.

As shown in FIG. 1, the first electrode 102 and the second electrode 104 can include a first current collector 108, and a second current collector 110, respectively. The first current collector 108 and the second current collector 110 may facilitate electrical coupling between the corresponding electrode and an external circuit (not shown). The first current collector 108 and the second current collector 110 can comprise one or more electrically conductive materials. The first current collector 108 and the second current collector 110 can have various shapes and/or sizes. The first current collector 108 and the second current collector 110 can be configured to facilitate transfer of electrical charges between the corresponding electrode and an external circuit. For example, the first current collector 108 can be electrically coupled to a first energy storage device terminal 122, such as an electrically positive terminal, via a first connection 126. The second current collector 110 may be electrically coupled to a second energy storage device terminal 124, such as an electrically negative terminal, via a second connection 128. The first and second energy storage device terminals, 122, 124, may be electrically coupled to respective terminals of an external circuit to couple the energy storage device 100 to the external circuit.

A current collector can include a metallic material, such as a material comprising aluminum, nickel, copper, silver, alloys thereof, and/or other metallic materials, or nonmetallic materials such as graphite which remain inert at the electrode potentials of the device. In some embodiments, the current collector further comprises a coating layer. In some embodiments, the coating layer comprises a carbon coating. The first current collector 108 and/or the second current collector 110 can comprise a foil. The first current collector 108 and the second current collector 110 can have a rectangular or substantially rectangular shape and can be dimensioned to provide the desired transfer of electrical charges between the corresponding electrode and an external electrical circuit. The energy storage device 100 can comprise any of a number of different configurations to provide said electrical communication between the electrodes 102, 104 and the external electrical circuit through the current collectors 108, 110, respectively. For example, said transfer can be provided via a current collector plate and/or another energy storage device component.

The first electrode 102 may have a first electrode film 112 (e.g., an upper electrode film) on a first surface of the first current collector 108 (e.g., on a top surface of the first current collector 108). The first electrode 102 may have a second electrode film 114 (e.g., a lower electrode film) on a second opposing surface of the first current collector 108 (e.g., on a bottom surface of the first current collector 108). Similarly, the second electrode 104 may have a first electrode film 116 (e.g., an upper electrode film) on a first surface of the second current collector 110 (e.g., on a top surface of the second current collector 110). The second electrode 104 may have a second electrode film 118 on a second opposing surface of the second current collector 110 (e.g., on a bottom surface of the second current collector 110). For example, the first surface of the second current collector 110 may face the second surface of the first current collector 108, such that the separator 106 is adjacent to the second electrode film 114 of the first electrode 102 and the first electrode film 116 of the second electrode 104.

The electrode films 112, 114, 116 and/or 118 can have a variety of suitable shapes, sizes, and/or thicknesses. For example, the electrode films can have a thickness of about 30 microns (μm) to about 2000 microns, including about 100 microns to about 250 microns, and further including about 30 microns to about 250 microns. The electrode films of 112, 114, 116 and/or 118 can have the same or different thicknesses, compositions, and densities with respect to each other. For example, the electrode films of 112 and 114 can have a different thickness, composition or density compared to the electrode films 116 and 118.

In some embodiments, an electrode film of an anode and/or a cathode of an energy storage device comprises a dry binder material, one or more active electrode components, and/or one or more electrical conductivity promoting additives. In some embodiments, the one or more active electrode components and one or more electrical conductivity promoting additives together form a dry composite material as described herein, such that the electrode film comprises a dry binder material and a dry composite material.

In some embodiments, the electrode film of an anode and/or a cathode can include one or more dry binder materials. In some embodiments, the dry binder can include polytetrafluoroethylene (PTFE), a polyolefin, polyalkylenes, polyethers, styrene-butadiene, co-polymers of polysiloxanes and polysiloxane, branched polyethers, polyvinylethers, co-polymers thereof, and/or admixtures thereof. The binder can include a cellulose, for example, carboxymethylcellulose (CMC). In some embodiments, the polyolefin can include polyethylene (PE), polypropylene (PP), polyvinylidene fluoride (PVDF), co-polymers thereof, and/or mixtures thereof. For example, the binder can include polyvinylene chloride, poly(phenylene oxide) (PPO), polyethylene-block-poly(ethylene glycol), poly(ethylene oxide) (PEO), poly(phenylene oxide) (PPO), polyethylene-block-poly(ethylene glycol), polydimethylsiloxane (PDMS), polydimethylsiloxane-coalkylmethylsiloxane, co-polymers thereof, and/or admixtures thereof. In some embodiments, the dry binder may be a thermoplastic. In some embodiments, the dry binder comprises a fibrillizable polymer. In some embodiments, a dry binder material can include one or more of a variety of suitable polymeric materials, such as polytetrafluoroethylene (PTFE), ultra-high molecular weight polyethylene (UHMWPE), polyvinylidene fluoride (PVDF), an acrylate (e.g., a melt processable acrylate), an acrylonitrile imide, an amide, a binder provided herein, and/or other suitable and optionally fibrillizable materials, used alone or in combination. In some embodiments, the electrode film may comprise a polymer, such as a polymer binder material, and one or more other components. Polymer is a general term and can include homo-polymers, co-polymers, and admixtures of polymers as provided herein. In some embodiments the polymer can be a dry binder material. In some embodiments, the electrode film may comprise a dry binder in, or in about, 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 8.5 wt %, 9 wt %, 9.5 wt % or 10 wt % or any range of values therebetween, for example, from about 1 wt % to about 10 wt %, wherein the wt % is based on the weight of the electrode film.

In some embodiments, the electrode film of an anode and/or a cathode can include one or more active electrode components. In some embodiments, the active electrode components may be selected from a silicon active material, a carbon active material, and combinations thereof. In some embodiments, the silicon active material can be selected from silicon (e.g., metallurgical silicon (MG Si)), silicon oxide (SiOₓ), silicon-carbon composite (Si—C or Si/C), silicon carbide (SiC) or combinations thereof. In some embodiments, the active electrode components may include a carbon active material. In some embodiments, the carbon active material may comprise a carbonaceous material. In some embodiments, the carbonaceous material may include soft carbon, hard carbon, graphite (e.g., natural graphite and artificial graphite), and combinations thereof. In some embodiments, the one or more active electrode components may comprise a porous carbon material, such as activated carbon. In some embodiments, the one or more active electrode components may comprise a carbon active material configured to reversibly intercalate lithium ions, such as graphite, soft carbon and/or hard carbon. In some embodiments, the electrode film and/or active electrode component may comprise additional active electrode materials. In some embodiments, additional active electrode material may be selected from an insertion material (e.g., carbon, and/or graphene), an alloying/dealloying material (e.g., Poxide, tin, and/or tin oxide), a metal alloy or compound (e.g., Si—Al, and/or Si—Sn), and/or a conversion material (e.g., manganese oxide, molybdenum oxide, nickel oxide, and/or copper oxide). The additional active materials can be used alone or mixed together to form multi-phase materials (e.g., Sn—C, SiOx-C, SnOx-C, Si—Sn, Si-SiOx, Sn-SnOx, Si-SiOx-C, Sn-SnOx-C, Si—Sn—C, SiOx-SnOx-C, Si-SiOx-Sn, or Sn-SiOx-SnOx). In some embodiments, the active electrode component may comprise a lithium metal oxide. In some embodiments the active electrode components may incorporate a lithium ion rich source for the purpose of pre-lithiating the anode, advantageously reducing or eliminating first cycle inefficiency. In some embodiments, the electrode film may comprise an active material in, or in about, 40 wt %, 45 wt %, 50 wt %, 55 wt %, 60 wt %, 65 wt %, 70 wt %, 75 wt %, 80 wt %, 82 wt %, 84 wt %, 85 wt %, 87 wt %, 89 wt %, 90 wt %, 92 wt %, 95 wt %, 97 wt %, 99 wt % or 99.5 wt % or any range of values therebetween, for example, from about 40 wt % to about 99.5 wt %, wherein the wt % is based on the weight of the electrode film. In some embodiments, the electrode film may comprise an active silicon material of about 1 wt % to about 10 wt % and a carbon active material of about 40 wt % to about 99.5 wt %.

In some embodiments, the electrode film of an anode and/or a cathode can include one or more additives, including electrical or ionic conductivity promoting additives. In some embodiments, the electrical conductivity promoting additive can be a carbon additive. In some embodiments, the carbon additive may include carbon nanotubes (CNT), a carbon black, carbon nano fibers (CNF), and combinations thereof. In some embodiments, the CNTs may include single walled carbon nanotubes (SWCNT), double walled carbon nanotubes (DWCNT), few walled carbon nanotubes (FWCNT), multiwalled carbon nanotubes (MWCNT), and combinations thereof. In some embodiments, the carbon black may comprise a conductive carbon black. In some embodiments, the carbon black may include acetylene black (AB), super P conductive carbon black, Ketjenblack (KB) carbon black, and combinations thereof. In some embodiments, the electrode film may comprise an carbon additive in, or in about, 0.05 wt %, 0.1 wt %, 0.2 wt %, 0.5 wt %, 1 wt %, 1.5 wt %, 2 wt %, 2.5 wt %, 3 wt %, 3.5 wt %, 4 wt % or any range of values therebetween, for example, from about 0.05 wt % to about 4 wt %, wherein the wt % is based on the weight of the electrode film.

In some embodiments, the electrode film may comprise a dry composite material in, or in about, 80 wt %, 82 wt %, 84 wt %, 86 wt %, 88 wt %, 90 wt %, 91 wt %, 92 wt %, 93 wt %, 94 wt %, 95 wt %, 96 wt %, 97 wt %, 98 wt %, 99 wt %, 99.5 wt %, or any range of values therebetween, for example, from about 90 wt % to about 99.5 wt %, from about 95 wt % to about 99.5 wt %, from about 97 wt % to about 98 wt % wherein the wt % is based on the weight of the electrode film.

In some embodiments, an electrode film, wherein the electrode film is dry and/or self-supporting film, may provide a high electrode material loading, or a high active material loading (which may be expressed as mass of electrode film per unit area of electrode film or current collector) of, or of about, 10 mg/cm², about 11 mg/cm², about 12 mg/cm², about 13 mg/cm², about 14 mg/cm², about 15 mg/cm², about 16 mg/cm², about 17 mg/cm², about 18 mg/cm², about 19 mg/cm², about 20 mg/cm², about 21 mg/cm², about 22 mg/cm², about 23 mg/cm², about 24 mg/cm², about 25 mg/cm², about 26 mg/cm², about 27 mg/cm², about 28 mg/cm², about 29 mg/cm², about 30 mg/cm², about 40 mg/cm², about 50 mg/cm², or any range of values therebetween, for example, about 10 mg/cm² to about 50 mg/cm².

In some embodiments, the electrode film can have an electrode film density of, or of about, 0.8 g/cm³, 1.0 g/cm³, 1.4 g/cm³, about 1.45 g/cm³, about 1.5 g/cm³, about 1.6 g/cm³, about 1.7 g/cm³, about 1.8 g/cm³, about 1.9 g/cm³, about 2.0 g/cm³, about 2.5 g/cm³, about 3.0 g/cm³, about 3.3 g/cm³, about 3.4 g/cm³, about 3.5 g/cm³, about 3.6 g/cm³, about 3.7 g/cm³ or about 3.8 g/cm³, or any range of values therebetween, for example, from about 0.8 g/cm³ to about 3.8 g/cm³.

### Dry Composite Material

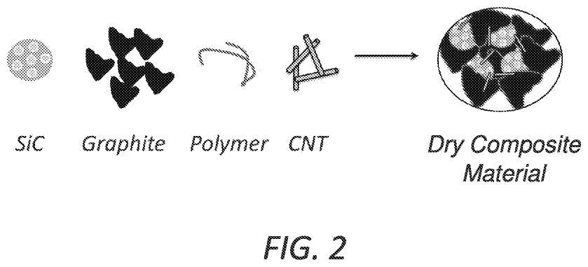

A dry composite material may include a carbon additive and an active material. In some embodiments, the carbon additive may include carbon nanotubes (CNT), a carbon black, carbon nano fibers (CNF), and combinations thereof. In some embodiments, the CNTs may include single walled carbon nanotubes (SWCNT), double walled carbon nanotubes (DWCNT), few walled carbon nanotubes (FWCNT), multiwalled carbon nanotubes (MWCNT), and combinations thereof. In some embodiments, the carbon black may comprise a conductive carbon black. In some embodiments, the carbon black may include acetylene black (AB), super P conductive carbon black, Ketjenblack (KB) carbon black, and combinations thereof. In some embodiments, the elements of the dry composite material (e.g., active material and carbon additive) are substantially homogeneously dispersed. In some embodiments, the elements of the dry composite material (e.g., active material and carbon additive) do not substantially aggregate or agglomerate. FIG. 2 is an example illustration of a dry composite material, wherein the dry composite material may comprise Si/C as a silicon active material, graphite as a carbon active material, a polymer composite binder, and CNT homogeneously dispersed therein. In some embodiments, the carbon nanotubes are single walled carbon nanotubes (SWCNT).

In some embodiments, the active material may be selected from a silicon active material, a carbon active material, and combinations thereof. In some embodiments, the silicon active material may be selected from silicon (e.g., metallurgical silicon (MG Si)), silicon oxide (SiOₓ), silicon-carbon composite (Si—C or Si/C), silicon carbide (SiC) or combinations thereof. In some embodiments, the silicon carbide may comprise a layered silicon carbide. In some embodiments, the carbon active material may comprise a carbonaceous material. In some embodiments, the carbonaceous material may include soft carbon, hard carbon, graphite (e.g., natural graphite and artificial graphite), and combinations thereof. In some embodiments, the one or more active electrode components comprise a porous carbon material, such as activated carbon. In some embodiments, the one or more active electrode components comprise a carbon material configured to reversibly intercalate lithium ions, such as graphite, soft carbon and/or hard carbon.

In some embodiments, the dry composite material may comprise additional active electrode materials. In some embodiments, additional active electrode material may be selected from an insertion material (e.g., carbon, and/or graphene), an alloying/dealloying material (e.g., Poxide, tin, and/or tin oxide), a metal alloy or compound (e.g., Si—Al, and/or Si—Sn), and/or a conversion material (e.g., manganese oxide, molybdenum oxide, nickel oxide, and/or copper oxide). The additional active materials can be used alone or mixed together to form multi-phase materials (e.g., Sn—C, SiOx-C, SnOx-C, Si—Sn, Si-SiOx, Sn-SnOx, Si-SiOx-C, Sn-SnOx-C, Si—Sn—C, SiOx-SnOx-C, Si-SiOx-Sn, or Sn-SiOx-SnOx).

In some embodiments, the dry composite material may further comprise a composite binder. In some embodiments, the composite binder may comprise a polymeric binder. In some embodiments, the composite binder may include a water based binder, an organic solvent based binder, and combinations thereof. In some embodiments, the composite binder may be selected from a polyacrylic acid (PAA), a cellulose (e.g., carboxymethylcellulose (CMC), an alginate (Alg) (e.g., sodium alginate (Na-Alg))), an acrylate (e.g., poly(methyl methacrylate) (PMMA), Li-PMMA), an acrylamide, a polyacrylamide (PAM), a gum (e.g., gum arabic, guar gum, chitosan, dextran), a sulfonated tetrafluoroethylene based fluoropolymer-copolymer (e.g., Nafion), a network polymer (e.g., an interpenetrating polymer network (IPN)), an acrylonitrile (e.g., a water based acrylonitrile (e.g., acrylonitrile multi-copolymer binder (LA-133))), an amide based binder, an imide based binder, an amide-imide binder, polyvinylidene fluoride (PVDF), copolymers thereof (e.g., PAA-PVA, PAA-CMC), and combinations thereof.

In some embodiments, the dry composite material may comprise impurities. In some embodiments, the impurities comprise Al, Cr, Fe, Li, Mg, Mn, Na, Ni, S, Zn, and combinations thereof. In some embodiments, the dry composite material may comprise impurities in an amount of, or of about, or less than, or less than about 10000 ppm, 8000 ppm, 5000 ppm, 3000 ppm, 2000 ppm, 1000 ppm, 800 ppm, 700 ppm, 500 ppm, 100 ppm, 50 ppm, or any range of values therebetween, for example, from about 50 ppm to about 10000 ppm.

In some embodiments, the dry composite material may comprise particles. In some embodiments, the particles may be dry particles free of solvents. In some embodiments, the dry composite material may have a median particle size (D50) of, or of about, 10 μm, 11 μm, 12 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm or 30 μm, or any range of values therebetween, for example, from about 10 μm to about 30 μm. In some embodiments, the dry composite material may have a specific surface area of, or of about, 1 m²/g, 1.1 m²/g, 1.2 m²/g, 1.3 m²/g, 1.4 m²/g, 1.5 m²/g, 1.6 m²/g, 1.7 m²/g, 1.8 m²/g, 1.9 m²/g, 2 m²/g or any range of values therebetween, for example, from about 1 m²/g to about 2 m²/g.

In some embodiments, an advantage of the present application is that the carbon additive, silicon active material and/or carbon active material are homogeneously dispersed or substantially homogeneously dispersed throughout the dry composite material. In some embodiments, substantial homogeneous dispersion or homogeneous dispersion may be illustrated by reduced or substantially reduced aggregation and/or phase separation of the active material and/or carbon additive in the dry composite material and in the dry electrode film fabricated using the dry composite material compared to an electrode film fabricated without using the dry composite material. For example, in some embodiments, the median particle size (D50) of the dry composite material may be, may be about, may be at most, or may be at most about, 300%, 275%, 250%, 225%, 200%, 175%, 150%, 140%, 130%, 120%, 110%, 100%, 90% or 80% of the median particle size (D50) of the silicon active material and/or carbon active material, or any range of values therebetween. In another example, in some embodiments, the specific surface area of the dry composite material may be, may be about, may be at most, or may be at most about, 50%, 60%, 70%, 80%, 90%, 100%, 110%, 120%, 130%, 140% or 150% of the specific surface area of the carbon active material and/or silicon active material, or any range of values therebetween. In an additional example, in some embodiments, aggregation of particles in the dry electrode film may be, may be about, may be at most, or may be at most about, 15 times, 10 times, 9 times, 8 times, 7 times, 6 times, 5 times, 4 times, 3 times, 2 times or 1.5 times of the size of the carbon active material and/or silicon active material, or any range of values therebetween.

In some embodiments, the dry composite material may comprise a carbon additive in, or in about, 0.01 wt %, 0.05 wt %, 0.1 wt %, 0.15 wt %, 0.20 wt %, 0.25 wt %. 0.3 wt %, 0.35 wt %, 0.40 wt %, 0.5 wt %, 0.6 wt %, 0.7 wt %, 0.8 wt %, 0.9 wt % or 1.0 wt %, or any range of values therebetween, for example, from about 0.01 wt % to about 1 wt %, wherein the wt % is based on the weight of the dry composite material. In some embodiments, the dry composite material may comprise a silicon active material by weight of about 2 wt %, 3 wt %, 4 wt %, 5 wt %, 6 wt %, 7 wt %, 8 wt %, 9 wt %, 10 wt % or any range of values therebetween, for example, from about 2 wt % to 10 wt %, wherein the wt % is based on the weight of the dry composite material. In some embodiments, the dry composite material may comprise a carbon active material of about 55 wt %, 80 wt %, 85 wt %, 90 wt %, 93 wt %, 94 wt %, 94.5 wt %, 95 wt %, 96 wt %, 97 wt %, 98 wt %, 99 wt % or any range of values therebetween, for example, from about 75 wt % to 99 wt %, wherein the wt % is based on the weight of the dry composite material.

### Methods of Fabricating Dry Composite Material

The dry composite material may be manufactured, and then may be utilized to fabricate an electrode film. In some embodiments, the dry composite material may be formed by a slurry process and/or a solvent-free process.

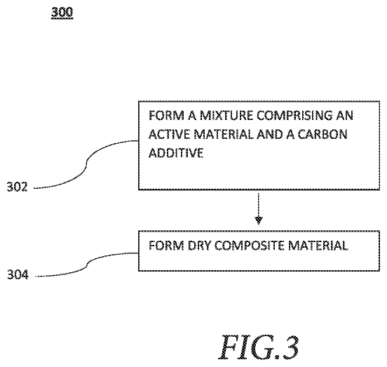

FIG. 3 is a process flow diagram of an embodiment of a process 300 for forming a dry composite material. The method to form a dry composite material 300 may include forming a mixture comprising a carbon additive and an active material in step 302. In some embodiments, the active material may be or include any active material (e.g., active electrode components) described herein. For example, in some embodiments, the active material may comprise a carbon active material, a silicon active material, or combinations thereof. In some embodiments, the active material may be selected from a group consisting of a carbon active material, a silicon active material, or combinations thereof. In some embodiments, the silicon active material is selected from silicon (e.g., metallurgical silicon (MG Si)), silicon oxide (SiOₓ), silicon-carbon composite (Si—C or Si/C), silicon carbide (SiC) or combinations thereof. In some embodiments, the carbon additive may include soft carbon, hard carbon, graphite (e.g., natural graphite and artificial graphite), and combinations thereof. In some embodiments, the carbon additive may include carbon nanotubes (CNT), a carbon black, carbon nano fibers (CNF), and combinations thereof. In some embodiments, the mixture may contain additional elements of the dry composite material, such as a composite binder. In some embodiments, for example such as in a spray-drying process, the mixture may be a slurry and further include a liquid. From the mixture, a dry composite material may be formed in step 304. In some embodiments, the dry composite material may be formed by a process selected from spray drying, tri-kneader mixing, fluidized bed mixing, freeze dry mixing, milling, mechanofusion, and combinations thereof. In some embodiments, for example such as in a spray-drying process, the dry composite material may be formed by removing the liquid and/or solvent from the mixture. In some embodiments, the dry composite material may be substantially free of solvent or liquid. In some embodiments, the dry composite material may maintain the substantially homogeneous distribution of components (e.g., the carbon additive, active material, and/or composite binder) across the dry composite material. In some embodiments, the resultant yield of the process for forming the dry composite material may be, or may be about, 40 wt %, 50 wt %, 55 wt %, 60 wt %, 65 wt %, 70 wt %, 80 wt % or 90 wt %, or any range of values therebetween, for example, from about 40 wt % to about 90 wt %, wherein the wt % is based on the weight of the mixture.

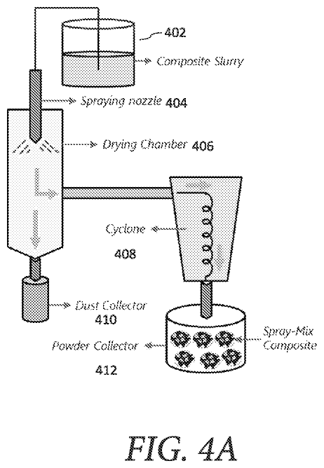

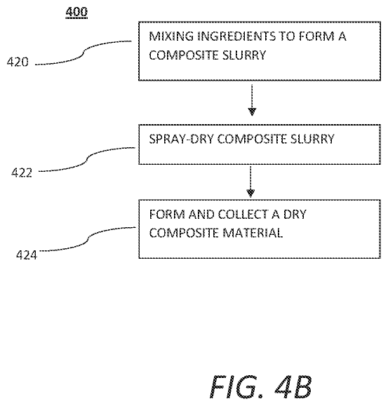

FIGS. 4A and 4B schematically illustrate a spray-drying apparatus and a method of using such a spray-drying apparatus for forming the dry composite material according to some embodiments. As illustrated in FIGS. 4A and 4B, in step 420, a slurry may be formed in container 402. In some embodiments, the slurry may be formed by mixing a solution of a carbon additive material and one or more active materials with a liquid. In some embodiments, a composite binder may be added to the mixture to form the slurry. In some embodiments, the active material may comprise a carbon active material, a silicon active material, or combinations thereof. In some embodiments, the active material may be Si/C composite and graphite. In some embodiments, the carbon additive may include carbon nanotubes (CNT), a carbon black, carbon nano fibers (CNF), and combinations thereof. In some embodiments, the carbon additive may be carbon nanotubes. In some embodiments, the slurry may be formed by mixing the ingredients by a mixer. In some embodiments, the slurry may be further diluted to achieve a desired weight percentage of the solid content. In step 422, the slurry may be spray dried by entering the drying chamber 406 through the spraying nozzle 404. After the slurry is spray dried in the chamber 406 in step 422, in step 424, the dried composite material may be formed and transported to a cyclone 408, and then collected in the powder collector 412. Dust collector 410 may be configured to collect any dust from the slurry which does not form the dried composite.

In some embodiments, the slurry may be formed by mixing the components of the dry composite material (e.g., a carbon additive and an active material; a carbon additive, an active material and a composite binder; or a carbon additive, a carbon active material, a silicon active material and a composite binder) with a liquid. In some embodiments, the liquid may comprise an aqueous solvent and/or an organic solvent. In some embodiments, the liquid may comprise water. In some embodiments, the components of the mixture (e.g., the carbon additive, active material, binder, and liquid) may be substantially homogenously mixed and/or distributed in the slurry mixture. In some embodiments, the slurry may be formed by mixing a solution comprising a carbon additive and a composite binder with a carbon active material and a silicon active material. In some embodiments, the solution may comprise a carbon additive of, or of about, 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.5 wt %, 2 wt %, 2.5 wt %, 3 wt %, 3.5 wt % or 4 wt % or any range of values therebetween, for example, from about 0.1 wt % to about 4 wt %, wherein the wt % is based on the weight of solution. In some embodiments, the solution may comprise a composite binder of, or of about, 0.5 wt %, 1 wt %, 1.5 wt %, 2 wt %, 2.5 wt %, 3 wt %. 3.5 wt %, 4 wt %, 4.5 wt %, 4.9 wt %, 5 wt %, 5.5 wt %, 6 wt %, 6.5 wt %, 7 wt %, 7.5 wt %, 8 wt %, 8.5 wt %, 9 wt %, 9.5 wt % or 10 wt % or any range of values therebetween, for example, from about 0.5 wt % to about 10 wt %, wherein the wt % is based on the weight of solution. In some embodiments, the slurry may be formed by mixing the solution (e.g., wherein the solution may comprise a carbon additive, a composite binder, a carbon active material and a silicon active material) using a mixer for a certain period of time. In some embodiments, the mixing time may be, or may be about, 200 seconds, 250 seconds, 300 seconds, 350 seconds, 365 seconds, 400 seconds, 450 seconds, 500 seconds, 550 seconds or 600 seconds or any range of values therebetween, for example, from about 200 seconds to about 600 seconds. In some embodiments, the mixing may be performed more than once, such as twice, three times, four times, five times, six times, or any times needed. In some embodiments, the speed of the mixer may be, or may be about, 500 rpm, 600 rpm, 700 rpm, 750 rpm, 800 rpm, 850 rpm, 900 rpm, 1000 rpm, 1100 rpm, 1200 rpm, 1300 rpm, 1400 rpm or 1500 rpm, or any range of values therebetween, for example, from about 500 rpm to about 1500 rpm.

In some embodiments, after the slurry is formed, the slurry may be further diluted. In some embodiments, diluting the slurry may comprise diluting the slurry to achieve a solid content of, or of about, 20 wt %, 25 wt %, 30 wt %, 35 wt %, 40 wt %, 45 wt %, 50 wt %, 55 wt % or 60 wt %, or any range of values therebetween, for example, between about 20 wt % to about 60 wt %, wherein the wt % is based on the weight of the slurry. In some embodiments, diluting the slurry may comprise diluting the slurry to achieve a viscosity of, of about, of less than, or of less than about, 500 cp, 450 cp, 400 cp, 350 cp, 300 cp, 250 cp, 200 cp, 150 cp or 100 cp or any range of values therebetween, for example, from about 100 cp to about 500 cp. In some embodiments, the dilution may be achieved by using a mixer (e.g., an overhead mixer).

In some embodiments, where a slurry mixture of components is used, the method to remove the solvent from the slurry may be spray drying. In some embodiments, the airflow rate of spray drying may be, or may be about, 50 cpm, 55 cpm, 60 cpm, 65 cpm, 70 cpm, 75 cpm, 80 cpm, 85 cpm, 90 cpm, 95 cpm or 100 cpm, or any range of values therebetween, for example, from about 50 cpm to about 100 cpm. In some embodiments, the inlet temperature for the spray drying may be, or may be about, 150° C., 170° C., 190°, 200° C., 210° C., 230° C., 250° C., 270° C., 290° C. or 300° C., or any range of values therebetween, for example, from about 150° C. to about 300° C. In some embodiments, the product temperature for the spray drying may be, or may be about, 80° C., 90° C., 100°, 110° C., 130° C., 150° C., 170° C., 190° C. or 200° C., or any range of values therebetween, for example, from about 80° C. to about 200° C. In some embodiments, the throughput for the spray drying may be, or may be about, 20 g/min, 30 g/min, 45 g/min, 50 g/min, 60 g/min, 70 g/min or 80 g/min, or any range of values therebetween, for example, from about 20 g/min to 80 g/min.

### Method of Using a Dry Composite Material in the Manufacture of Electrode Films and Energy Storage Devices

The dry composite material may be utilized to form an electrode film. The electrode film comprising the dry composite material may be utilized to form an electrode and energy storage device, for example such as those described herein. Advantageously, the dry electrode film disclosed herein can comprise a conductive carbon network across the dry electrode film in contact with the carbon active material and/or silicon active materials. In addition, aggregation and phase separation of the active material can be significantly reduced comparing to a dry electrode film fabricated with raw ingredients instead of using the dry composite material. Therefore, the cycle life performance and capacities of the energy storage device fabricated with the dry electrode film according to some embodiments can be improved, and the expected capacity can be fully utilized.

After the dry composite material is formed, a dry electrode film can be formed with the dry composite material. In some embodiments, the dry electrode film comprising the dry composite material may be manufactured by a dry or a wet fabrication process. As used herein, a dry fabrication process or a dry process can refer to a process in which no or substantially no solvents are used in the formation of an electrode film.

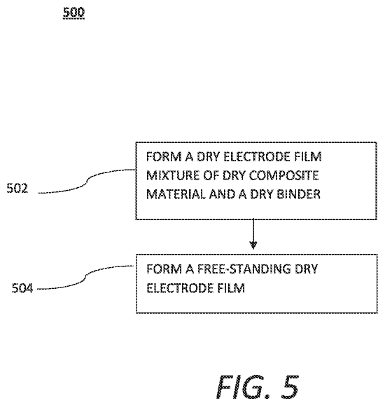

For example, FIG. 5 is a process flow diagram of an embodiment of a process 500 for forming a dry electrode film. As illustrated in FIG. 5, a dry electrode film mixture comprising the dry composite material and a dry binder may be mixed in step 502. In step 504, a free-standing dry electrode film may be formed from the electrode film mixture. In some embodiments, the dry electrode film may be formed by a dry-fabrication process.

In some embodiments, components of the active layer or electrode film may comprise dry particles, such as the dry composite material. The dry particles for forming the active layer or electrode film may be combined with a dry binder to provide an electrode film mixture. In some embodiments, the active layer or electrode film may be formed from the electrode film mixture such that weight percentages of the components of the active layer or electrode film and weight percentages of the components of the electrode film mixture are substantially the same. In some embodiments, the active layer or electrode film formed from the electrode film mixture using the dry fabrication process may be free from, or substantially free from, any processing additives such as solvents and solvent residues resulting therefrom. In some embodiments, the resulting active layer or electrode films are self-supporting films formed using the dry process from the dry particle mixture. In some embodiments, the resulting active layer or electrode films are free-standing films formed using the dry process from the electrode film mixture. A process for forming an active layer or electrode film can include fibrillizing the fibrillizable binder component(s) such that the film may comprise fibrillized binder. In further embodiments, a free-standing active layer or electrode film may be formed in the absence of a current collector. In still further embodiments, an active layer or electrode film may comprise a fibrillized polymer matrix such that the film is self-supporting. It is thought that a matrix, lattice, or web of fibrils can be formed to provide mechanical structure to the electrode film.

In some embodiments, the electrode film mixture may comprise a dry binder in, or in about, 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 8.5 wt %, 9 wt %, 9.5 wt % or 10 wt % or any range of values therebetween, for example, from about 1 wt % to about 10 wt %, wherein the wt % is based on the weight of the electrode film mixture.

In some embodiments, the dry binder may comprise a polymeric binder. In some embodiments, the dry binder can include polytetrafluoroethylene (PTFE), a polyolefin, polyalkylenes, polyethers, styrene-butadiene, co-polymers of polysiloxanes and polysiloxane, branched polyethers, polyvinylethers, co-polymers thereof, and/or admixtures thereof. The binder can include a cellulose, for example, carboxymethylcellulose (CMC). In some embodiments, the polyolefin can include polyethylene (PE), polypropylene (PP), polyvinylidene fluoride (PVDF), co-polymers thereof, and/or mixtures thereof. For example, the binder can include polyvinylene chloride, poly(phenylene oxide) (PPO), polyethylene-block-poly(ethylene glycol), poly(ethylene oxide) (PEO), poly(phenylene oxide) (PPO), polyethylene-block-poly(ethylene glycol), polydimethylsiloxane (PDMS), polydimethylsiloxane-coalkylmethylsiloxane, co-polymers thereof, and/or admixtures thereof. In some embodiments, the binder may be a thermoplastic. In some embodiments, the dry binder may comprise a fibrillizable polymer.

In some embodiments, the size of the components and/or particles of the electrode film mixture may be reduced by using high-shear equipment and processes, such as jet-milling. The high shear forces can be provided to separate the binder material agglomerates into finely divided particles and/or fibrillize the binder material, such that the binder material can coat the other electrode film components. In some embodiments, the resulting dry processed powder may be compressed with heat and pressure using a roll mill to form a film, such as by the PTFE cohering and adhering to other components of the film, for example, in a fibrillized matrix. The thickness of the film may depend on the roll gap of the roll mill, pressure applied during the compression process, and/or number of times the film is compressed. The dry fabrication process may result in a fibrillized matrix such that the electrode film is self-supporting and/or free-standing.

In some embodiments, one or more electrode film mixtures described herein may be combined with one or more other electrode film components and subsequently calendared to form an electrode film. The electrode film may be one or more of the electrode films described with reference to FIG. 1. The electrode films described herein can be used to form anodes and/or cathodes of an energy storage device, for example, batteries, capacitors, capacitor-battery hybrids, fuel cells, combinations thereof, and the like. The energy storage device may operate with or without lithium. In some embodiments, the electrode films can be used to fabricate batteries, such as lithium ion batteries, or other metal ion batteries. In some embodiments, the electrode films can be used to fabricate ultracapacitors, such as electric double layer capacitors (EDLC). In some embodiments, the electrode films can be used to fabricate lithium ion capacitors. The electrode film may be a self-supporting electrode film as provided herein.

In some embodiments, the dry electrode film formed from an electrode film mixture provided herein may be suitable for use in an anode or cathode of an energy storage device. For example, the dry electrode film may be coupled to a current collector of an anode or cathode to form a dry electrode, such as by using a lamination process. In some embodiments, the dry electrode film may be laminated on a current collector. In some embodiments, lamination is performed at a high temperature (e.g., 50-100° C.).

In some embodiments, the dry electrode according to some embodiments may be utilized in half-cell. In some embodiments, the half-cell may be formed by using the dry electrode disclosed herein with a metal electrode as a counter and reference electrode. In some embodiments, the metal electrode may be a lithium metal electrode. In some embodiments, the half-cell may further comprise an electrolyte comprising the metal ion of the metal electrode between the dry electrode and metal electrode. In some embodiments, the capacity of the dry electrode according to some embodiments fully realizes the expected capacity calculated based on the capacity and weight of active material in the half-cell. In some embodiments, the discharge capacity of a dry electrode according to some embodiments in a half-cell may be, or may be about, 300 mAh/g, 350 mAh/g, 400 mAh/g, 410 mAh/g, 420 mAh/g, 450 mAh/g, 500 mAh/g, 550 mAh/g, 600 mAh/g, 650 mAh/g, 700 mAh/g, 750 mAh/g, 800 mAh/g, 850 mAh/g, 900 mAh/g, 950 mAh/g or 1000 mAh/g, or any range therebetween, for example, from about 300 mAh/g to about 1000 mAh/g. In some embodiments, the first cycle efficiencies (FCE) of the half-cell according to some embodiments may be, may be about, may be at least, or is at least about, 80%, 85%, 86%, 87%, 88%, 89%, 90%, 91%, 92%, 93%, 95%, 96%, 97%, 98% or 99%, or any range therebetween.

In some embodiments, the electrode formed herein may be incorporated in an energy storage device for example, a full-cell lithium ion battery, as shown in FIG. 1. In some embodiments, the electrode disclosed herein may be an anode. In some embodiments, the electrode according to some embodiments may be placed in an energy storage device and sealed with a housing. In some embodiments, an electrolyte may be added in the energy storage device and is sealed with housing. In some embodiments, the electrolyte may be a lithium containing electrolyte comprising a lithium salt. Generally, the lithium salt may include an anion that is redox stable. In some embodiments, the anion can be monovalent. In some embodiments, a lithium salt can be selected from hexafluorophosphate (LiPF₆), lithium tetrafluoroborate (LiBF₄), lithium perchlorate (LiClO₄), lithium bis(trifluoromethansulfonyl)imide (LiN(SO₂CF₃)₂), lithium trifluoromethansulfonate (LiSO₃CF₃), lithium bis(oxalate)borate (LiBOB) and combinations thereof. In some embodiments, the electrolyte can include a quaternary ammonium cation and an anion selected from the group consisting of hexafluorophosphate, tetrafluoroborate and iodide. In some embodiments, the salt concentration is, or is about, 0.2 M, 0.3 M, 0.4 M, 0.5 M, 0.6 M, 0.7 M, 0.8 M, 0.9 M, 1 M, 1.1 M or 1.2 M, or any range of values therebetween.

In some embodiments, the capacity of the lithium ion batteries with the dry electrode may be configured to maintain a capacity of, of about, of at least, or of at least about, 80%, 85%, 90%, 91%, 92%, 93%, 94%, 95%, 96%, 97%, 98% or 99%, or any range of values therebetween, of the capacity in the first cycle at or after 100 cycles, 200 cycles, 500 cycles, or 1000 cycles, or any range of values therebetween. In some embodiments, the initial discharge capacity of a dry electrode according to some embodiments in a full-cell is, or is about, 100 mAh/g, 150 mAh/g, 200 mAh/g, 250 mAh/g, 300 mAh/g, 400 mAh/g, 450 mAh/g, 500 mAh/g, 550 mAh/g or 600 mAh/g or any range therebetween, for example, from about 100 to about 600 mAh/g. In some embodiments, the first cycle efficiencies (FCE) of a dry electrode according to some embodiments in a full-cell is, is about, is at least, or is at least about, 80%, 85%, 86%, 87%, 88%, 89%, 90%, 91%, 92%, 93%, 95%, 96%, 97%, 98% or 99%, or any range therebetween, for example, about from 80% to about 99%.

In some embodiments, the energy storage device (e.g., lithium ion battery) is configured to operate at, or at about, 2.5 to 4.5 V, or 2.8 to 4.2 V. In further embodiments, the energy storage device (e.g., lithium ion battery) may be configured to have a minimum operating voltage of, or of about, 2.5 V to about 3 V. In still further embodiments, the energy storage device (e.g., lithium ion battery) is configured to have a maximum operating voltage of, or about, 4.1 V to about 4.5 V.

### EXAMPLES

### Example 1: Fabrication of Dry Composite Material

Dry composite materials according to some embodiments were fabricated. Table 1 summarizes the compositions for Dry Composite Material Nos. 1-4. Other dry composite material compositions can be envisioned and prepared, and the disclosure herein is not limited to the specific compositions disclosed.

TABLE 1

| Dry | | | | | |
|---|---|---|---|---|---|
| Composite | SWCNT | Si/C | Graphite | CMC | PAA |
| Material Nos. | (wt %) | (wt %) | (wt %) | (wt %) | (wt %) |
| 1 | 0.5 | 5 | 93.75 | 0.75 | / |
| 2 | 0.25 | 5 | 94.38 | 0.38 | / |
| 3 | 0.1 | 5 | 94.75 | 0.15 | / |
| 4 | 0.25 | 5 | 93.88 | 0.38 | 0.5 |

Dry Composite Material #1 was fabricated by first diluting 500 mg solution comprising 0.8% by weight of single-walled carbon nanotube (SWCNT) and 1.2% CMC by weight with 500 mg of water. Then 40 mg of Si/C composite and 750 mg of graphite were added in the above diluted solution and were mixed by a mixer at 800 rpm for 365 seconds twice, and a slurry was formed after the mixing. The slurry was then diluted with water to achieve a 40% solid content using overhead mixer to achieve a viscosity of less than about 400 cp. Then the slurry was spray dried in a spray dryer with an airflow rate of 70 cfm, inlet temperature of 210° C., and product temperature of 130° C., nozzle air pressure of 25 psi, pump speed of 8 rpm, and throughput of 45 g/min. The resultant yield was about 60% to about 80% by weight.

Dry Composite Materials #2-3 were fabricated through the same processes with varying amounts of SWCNT and CMC solution, graphite and Si/C composite based on the composition percentage summarized in Table 1.

Dry Composite Materials #4 was fabricated by mixing a required amount of a solution comprising 4.9% poly acrylic acid (PAA) by weight and 0.1% SWCNT by weight with a required amount of graphite and Si/C composite according to the compositions summarized in Table 1. The slurry was subsequently diluted with water to achieve a 40% solid content using an overhead mixer to achieve a viscosity of less than about 400 cp. The slurry was then spray dried in a spray dryer with an airflow rate of 70 cfm, inlet temperature of 210° C., product temperature of 130° C., nozzle air pressure of 25 psi, pump speed of 8 rpm, and throughput of 45 g/min. The resultant yield was about 60% to about 80% by weight and in the form of powder.

Table 2 summarizes the median diameter (D50) and the percentage of Si/C composite of Dry Composite Materials #1-4.

TABLE 2

| Dry | | Particle | Si/C content |
|---|---|---|---|
| Composite | | Size- | in powder wt % |
| Material Nos. | Composition | D50 (μm) | (from TGA) |
| 1 | Spray mixed 5% Si/C + | 25.7 | 5.3 |
| | Graphite + 0.5% SWCNT | | |
| 2 | Spray mixed 5% Si/C + | 22.6 | 5.8 |
| | Graphite + 0.25% SWCNT | | |
| 3 | Spray mixed 5% Si/C + | 16.3 | 4.8 |
| | Graphite + 0.10% SWCNT | | |
| 4 | Spray mixed 5% Si/C + | 23.8 | 5.4 |
| | Graphite + 0.25% SWCNT + | | |
| | 0.5% PAA | | |

The percentage of Si/C composite content was obtained by using thermogravimetric analysis (TGA) and the D50 values were obtained by using particle size analyzer (PSA). The D50 values increase with the increase of amount of CNT. In addition, the D50 values for the dry composite materials using PAA as the binder are larger than that of the dry composite materials using CMC as the binder. The Si/C content is close to the target range of about 5% by weight.

### Example 2: Characterization of Dry Composite Material

FIG. 6 illustrates particle-size distribution of Dry Composite Material #2 and Dry Composite Material #3. Table 3 summarizes the median diameter (D50) and the specific surface area (SSA) of graphite used for fabricating dry composite material, Dry Composite Material #2 and Dry Composite Material #3. As shown in FIG. 6 and Table 3, the particle size distributions of Dry Composite Material #2 and Dry Composite Material #3 do not shift towards a larger particle size by a lot from the particle size distribution of graphite, and the values of a specific surface area of Dry Composite Material #2 and Dry Composite Material #3 do not change much from that of graphite. Such experimental results show that there is no aggregation of graphite in Dry Composite Material #2 and Dry Composite Material #3.

TABLE 3

| | | Dry Composite | Dry Composite |
|---|---|---|---|
| | | Material #2 | Material #3 |
| | Graphite | (with 0.25% CNT) | (With 0.10% CNT) |
| Particle Size- | 16.8 | 22.6 | 16.9 |
| D50 | | | |
| (μm) | | | |
| SSA | 1.31 | 1.38 | 1.31 |
| (m²/g) | | | |

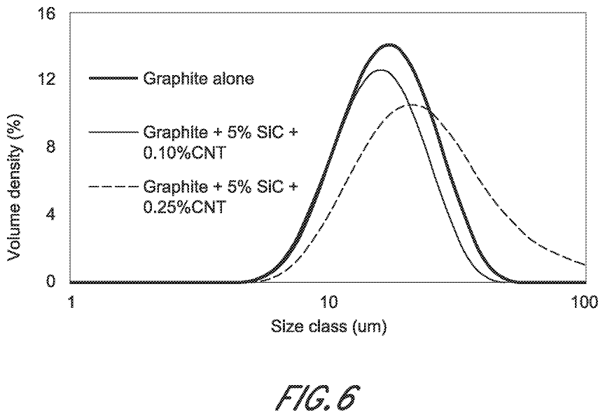

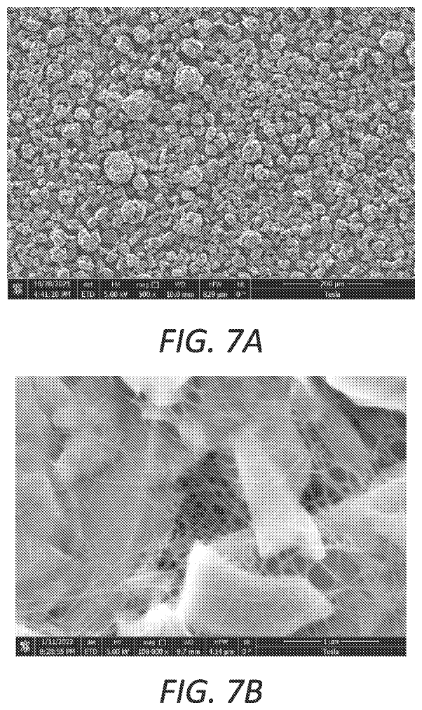

The morphology of the dry composite material was evaluated using Scanning Electron Microscope (SEM). FIG. 7A shows an SEM image of the surface of the dry composite material according to some embodiments. FIG. 7B is an enlarged SEM image of the SEM shown in FIG. 7B. In a conventional dry process, the carbon nanotubes and the powders of active material such as graphite and silicon material may undergo significant aggregation and phase separation because carbon nanotubes have large surface areas. In contrast, as shown in FIGS. 7A and 7B, the carbon nanotubes form a network across the dry composite material, the Si/C composite and graphite are homogenously dispersed in the dry composite material and are in contact with the carbon nanotube networks.

### Example 3: Fabrication of Dry Electrodes

Dry battery anodes comprising the dry composite materials according to some embodiments were fabricated. The dry electrode anodes include 2% PTFE by weight and 0.5% polyvinylidene difluoride (PVDF) by weight in addition to the dry composite materials. The dry battery films were prepared by first mixing PTFE and PVDF with the dry composite material at 90%, 60 Hz intensity for 5 minutes using a non-destructive mixer and then followed by higher shear mixing. The obtained powders were calendared at optimum temperature and gap setting to meet the required loading of 14-15.2 mg/cm² and 1.5 g/cc density. Finally, the dry battery films were calendared on a carbon-coated copper sheet to fabricate the dry battery anode.

Table 4 summarizes the composition, loading, and density for dry battery anodes fabricated with Dry Composite Materials #2 and #3

TABLE 4

| Dry | | | | |
|---|---|---|---|---|
| Composite | Spray Mix | Anode | Loading | Density |
| Material Nos. | Composition | Composition | (mg/cm²) | (g/cc) |
| #2 | Spray mixed | 97.5% | 14.3 | 1.44 |
| | 5% SiC + | composite + 2% | | |
| | Graphite + 0.25% | PTFE + 0.5% | | |
| | SWCNT | PVDF | | |
| #3 | Spray mixed | 97.5% | 15.0 | 1.45 |
| | 5% SiC + | composite + 2% | | |
| | Graphite + 0.10% | PTFE + 0.5% | | |
| | SWCNT | PVDF | | |

A normal dry battery anode (labeled as “Control”) without using the dry composite material was also fabricated to compare with the dry battery anodes including the dry composite material. The Control electrode was formed by first mixing 92.5% graphite by weight, 5% Si/C composite by weight, 2% PTFE by weight and 0.5% PVDF by weight directly and then prepared through a dry process.

Cathodes were also fabricated in a dry process, the cathodes including 97% by weight NMC811, 1% by weight conductive additive, and 2% by weight polymer binder.

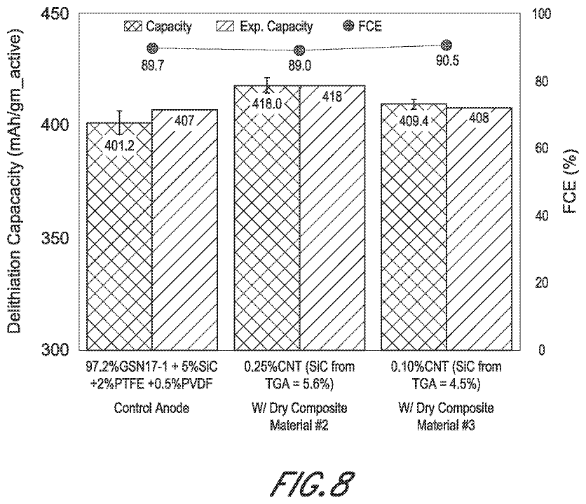

FIG. 8 illustrates the values of the half-cell capacity of dry battery anodes formed with a dry composite material according to some embodiments and without a dry composite material. The dry battery anode formed without a dry composite material is labeled as “Control.” During the half-cell test, it first discharged the half-cell till 0.05V at C/20 with C/100 hold and then charged the half-cell till 1V at C/20 with C/100 recovery at temperature of 25° C.

As shown in FIG. 8, the first cycle efficiencies (FCE) of dry battery anode formed with Control anode, Dry Composite Materials #2 and #3 are about 89.7%, 89%, and 90.5%, respectively, which shows that the dry battery anode comprising Dry Composite Materials #2 and 3 shows improved or at least similar first cycle efficiency comparing to a dry anode that does not comprise a dry composite material. The dry battery anode formed with Dry Composite Materials #2 and #3 have a capacity of 418 mAh/g and 409.4 mAh/g respectively, which are both improved relative to the capacity of Control anode (401.2 mAh/g). In addition, the dry battery anodes with dry composite material realizes the full utilization of the calculated capacity. In contrast, the dry anode formed without dry composite material does not realize the full utilization of the expected capacity.

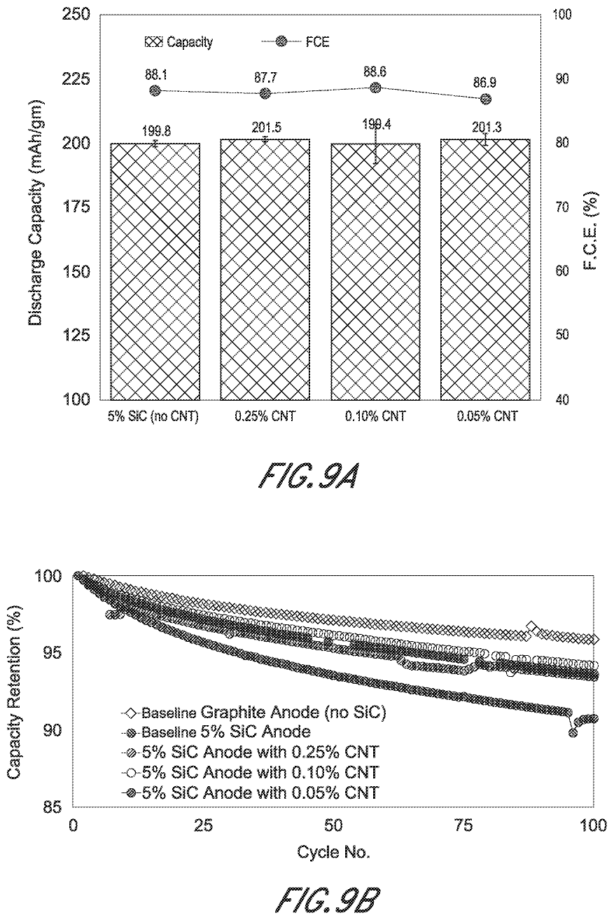

FIG. 9A illustrates the values of discharge capacity of dry battery anodes without CNT, with 0.25% CNT by weight, with 0.1% CNT by weight, and with 0.05% CNT by weight in a full cell test. The cathode in this full-cell test is NMC811 cathode. As shown in FIG. 9A, the discharge capacities of the dry battery anodes without CNT, with 0.25% CNT by weight, with 0.1% CNT by weight, and with 0.05% CNT are about 199.8 mAh/g, 201.5 mAh/g, 199.4 mAh/g, and 201.3 mAh/g, respectively. The first cycle efficiencies (FCE) of the dry battery anodes without CNT, with 0.25% CNT by weight, with 0.1% CNT by weight, and with 0.05% CNT are about 88.1%, 87.7%, 88.6%, and 86.9%, respectively. Therefore, the capacities of the dry Si/C anodes with the addition of carbon nanotubes are improved or similar to the capacities of a dry electrode without addition of carbon nanotubes. The FCE of the dry anodes with the addition of carbon nanotubes are similar to the FCE of a dry electrode without addition of carbon nanotubes.

FIG. 9B illustrates cycle life performance of the dry battery anodes without CNT, with 0.25% CNT by weight, with 0.1% CNT by weight, and with 0.05% CNT by weight in a full cell test. The test used a 300 mAh pouch-type full cells. The full cells were assembled with dry NMC811 cathodes. In each cycle, the batteries were charged and discharged between 4.2V to 2.85V at 40° C. with a rate of C/20. As shown in FIG. 9B, the dry Si/C battery anodes with CNT retained about 95% of capacity after 100 cycles and had improved capacity retention relative to a dry Si/C battery anode without CNT.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and within less than 0.01% of the stated amount, depending on the desired function or desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

The headings provided herein, if any, are for convenience only and do not necessarily affect the scope or meaning of the devices and methods disclosed herein.

1. A dry composite material for an energy storage device, the dry composite material comprising:
a silicon active material;
a carbon active material; and
a carbon additive,
wherein the carbon additive, silicon active material and carbon active material are substantially homogeneously dispersed in the dry composite material.

2. The dry composite material of claim 1, wherein the carbon additive is selected from the group consisting of carbon nanotubes, a carbon black, carbon nanofibers, and combinations thereof.

3. The dry composite material of claim 1, wherein the carbon additive is a conductive additive.

4. The dry composite material of claim 1, wherein the carbon additive forms a matrix.

5. The dry composite material of claim 1, wherein a surface area of the dry composite material is at least about 1.2 m²/g.

6. The dry composite material of claim 1, wherein a D50 particle size of the dry composite material is at least about 16 μm.

7. The dry composite material of claim 1, wherein the silicon active material is selected from the group consisting of silicon, a silicon derivative, and combinations thereof.

8. The dry composite material of claim 7, wherein the silicon derivative is selected from the group consisting of silicon oxide (SiOₓ), a silicon carbide (SiC), a silicon-carbon composite (Si/C), and combinations thereof.

9. The dry composite material of claim 1, wherein the carbon active material comprises graphite, soft carbon, hard carbon, and combinations thereof.

10. The dry composite material of claim 1, wherein the dry composite material further comprises a composite binder.

11. The dry composite material of claim 10, wherein the composite binder is selected from the group consisting of a polyacrylic acid (PAA), a cellulose, an alginate (Alg), an acrylate, an acrylamide, a polyacrylamide (PAM), a gum, a sulfonated tetrafluoroethylene based fluoropolymer-copolymer, a network polymer, an acrylonitrile, an amide based binder, an imide based binder, an amide-imide binder, polyvinylidene fluoride (PVDF), copolymers thereof, and combinations thereof.

12. The dry composite material of claim 1, wherein the dry composite material is substantially free of solvent residue.

13. An electrode film comprising the dry composite material of claim 1.

14. The electrode film of claim 13, further comprising a dry binder.

15. The electrode film of claim 14, wherein the dry binder is selected from the group consisting of polytetrafluoroethylene (PTFE), ultra-high molecular weight polyethylene (UHMWPE), polyvinylidene fluoride (PVDF), an acrylate, an acrylonitrile imide, an amide, and combinations thereof.

16. The electrode film of claim 13, wherein the electrode film is free-standing and substantially free of solvent residue.

17. An electrode comprising the electrode film of claim 13 disposed over a current collector.

18. An energy storage device comprising the electrode of claim 17.

19. The energy storage device of claim 18, wherein a capacity of the electrode after 100 cycles is at least about 95% of the capacity of the electrode in a first cycle.

20. The energy storage device of claim 18, wherein a capacity of the electrode is at least about 400 mAh/mg in a first cycle.

21. A method for preparing a dry composite material for an energy storage device electrode, the method comprising:
forming a mixture comprising a silicon active material, a carbon active material, and a carbon additive; and
forming the dry composite material comprising the silicon active material, the carbon active material, and the carbon additive, wherein the carbon additive, silicon active material and carbon active material are substantially homogeneously dispersed throughout the dry composite material.

22. The method of claim 19, wherein the mixture is a slurry and further comprises a solvent, and wherein forming the dry composite material further comprises removing the solvent.

23. The method of claim 21, wherein the mixture further comprises a composite binder.

24. The method of claim 21, wherein forming the dry composite material is a process selected from the group consisting of spray drying, tri-kneader mixing, fluidized bed mixing, freeze dry mixing, milling, mechanofusion, and combinations thereof.

25. A method for preparing a dry electrode film for an energy storage device electrode, the method comprising:
mixing the dry composite material of claim 1 with a dry binder to form a dry electrode film mixture; and
forming a free-standing dry electrode film from the dry electrode film mixture.

26. The method of claim 25, wherein forming the free-standing dry electrode film is a dry process.
